(19) United States
(12) Patent Application Publication
(10) Pub. No.: US 2012/0086615 A1
(43) Pub. Date: Apr. 12, 2012

(54) Method and Apparatus for an Integrated Antenna

(76) Inventor: John Peter Norair, San Francisco, CA (US)

(21) Appl. No.: 13/270,959

(22) Filed: Oct. 11, 2011

Related U.S. Application Data
(60) Provisional application No. 61/404,842, filed on Oct. 12, 2010.

(51) Int. Cl. H01Q 1/36; H01Q 1/00

(52) U.S. Cl. 343/720; 343/895; 343/787

(57) ABSTRACT

Aspects of a method and apparatus for an integrated antenna are provided. In an exemplary embodiment of the invention, a substrate may comprise one or more metal traces thereon and/or embedded therein. The substrate may be sufficiently flexible to be bent or molded into a shape that corresponds to the outer dimensions of a battery. When the substrate is bent into the shape corresponding to the outer dimensions of the battery, the one or more metal traces may form an antenna. A ferromagnetic laminate may be affixed to a first side of the substrate, and a dielectric laminate may be affixed to a second side of the substrate. The substrate may be wrapped around a battery and the battery and substrate may be integrated into a smartcard or other wireless communication device.

### CLAIM OF PRIORITY

This patent application makes reference to, claims priority to and claims benefit from U.S. Provisional Patent Application Ser. No. 61/404,842 filed on Oct. 12, 2010.

The above priority application is hereby incorporated herein by reference in its entirety.

### INCORPORATION BY REFERENCE

This patent application also makes reference to:

U.S. Provisional Patent Application Ser. No. 61/404,840 filed on Oct. 12, 2010; and
U.S. patent application Ser. No. 13/270,802, filed on Oct. 11, 2011.

The above-referenced applications are hereby incorporated herein by reference in their entirety.

### FIELD OF THE INVENTION

Certain embodiments of the invention relate to electronics. More specifically, certain embodiments of the invention relate to a method and apparatus for an integrated antenna.

### BACKGROUND OF THE INVENTION

Existing antennas are too bulky and inefficient. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for an integrated antenna, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

FIG. 1 depicts an exemplary antenna sleeve wrapped around a cylindrical battery.

FIG. 2 depicts an antenna sleeve which comprises a loop antenna and a sleeve for a flat cell battery.

FIG. 3 is a plan view of an exemplary multi-layer antenna sleeve.

FIG. 4 depicts various layers of the antenna sleeve of FIG. 3.

FIG. 5 depicts an exemplary smartcard comprising an integrated batter and antenna.

### DETAILED DESCRIPTION OF THE INVENTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be implemented in hardware, software, firmware, or any combination of one or more thereof. As utilized herein, the term “exemplary” means serving as a non-limiting example, instance, or illustration. As utilized herein, the term “e.g.,” introduces a list of one or more non-limiting examples, instances, or illustrations.

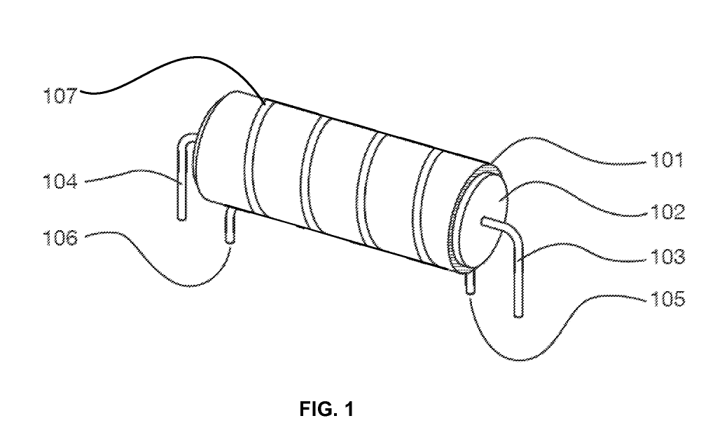

FIG. 1 depicts an exemplary antenna sleeve wrapped around a cylindrical battery. Shown in FIG. 1 is a battery 102 comprising leads 103 and 104, and an antenna sleeve 101 comprising antenna 107 and leads 105 and 106.

The antenna sleeve 101 may comprise a substrate which may have one or more traces on and/or within it. When the sleeve 101 is bent or molded into the shape of the battery 102 (e.g., by being wrapped around the battery 102), the traces may form the antenna 107. The substrate may comprise ferromagnetic material and/or have a ferromagnetic laminate on at least one side of it.

The antenna 107 of the exemplary sleeve 101 is a helical antenna with an elliptical cross section as a result of the cylindrical battery 102. In other embodiments of the invention, the battery may be shaped differently and the antenna 107 may have a different geometry. As an example, the antenna 107 may be a rectangular helix when wrapped around a rectangular battery 102. As another example, the antenna 107 may comprise one or more loop antennas.

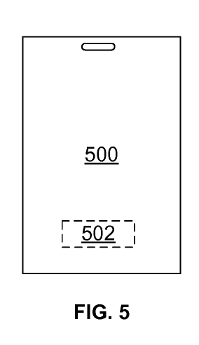

In operation, the battery 102 may supply power to a device (e.g., the smartcard 500 depicted below in FIG. 5) via the leads 103 and 104, and signals may be coupled to and/or from the antenna via the leads 105 and 106.

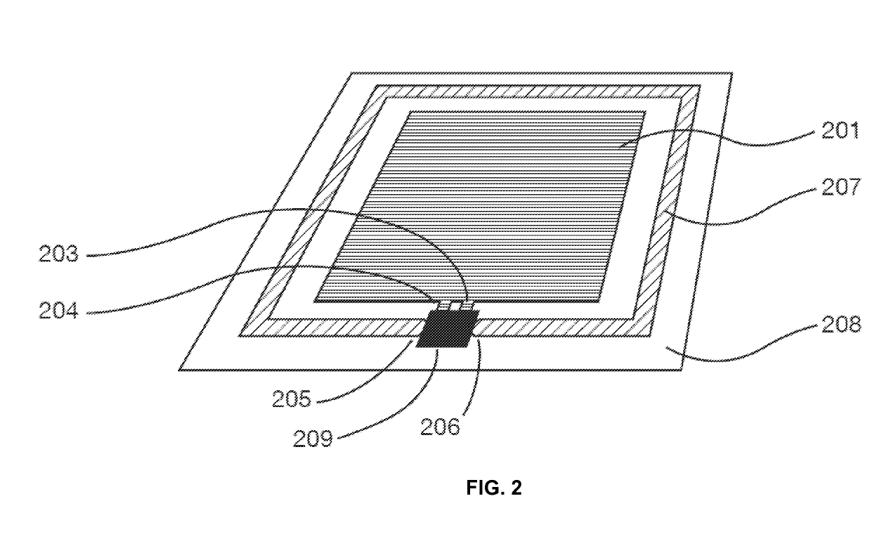

FIG. 2 depicts an antenna sleeve which comprises a loop antenna and a sleeve for a flat cell battery. Shown in FIG. 2 is a battery sleeve 201, battery leads 203 and 204, antenna 207, antenna leads 205 and 206, substrate 208, and an antenna driver circuit 206.

A battery (not shown) may be inserted into the battery sleeve 201. When a battery is in the sleeve 201, its positive terminal may connect to the battery lead 203 and its negative terminal may connect to the battery lead 204. In an exemplary embodiment of the invention, the battery sleeve 201 may be constructed of ferromagnetic material. In an exemplary embodiment of the invention, the battery housing may be a sleeve constructive of a flexible material, which may also be ferromagnetic.

In an exemplary embodiment of the invention, a battery inserted into the sleeve 201 may be made, at least in part, of ferromagnetic material.

The exemplary antenna 207 is a single loop antenna.

The antenna driver circuit 209 may comprise circuitry operable to receive power from a battery via leads 203 and 204, transmit RF signals via the antenna leads 205 and 206, and/or receive signals via the antenna leads 205 and 206. In an exemplary embodiment of the invention, the antenna driver circuit 209 may comprise a power amplifier, a low-noise amplifier, one or more filters, a digital-to-analog converter, an analog-to-digital converter, circuitry operable to process digital signals, and/or a memory.

The substrate 208 may, for example, comprise a flexible dielectric material.

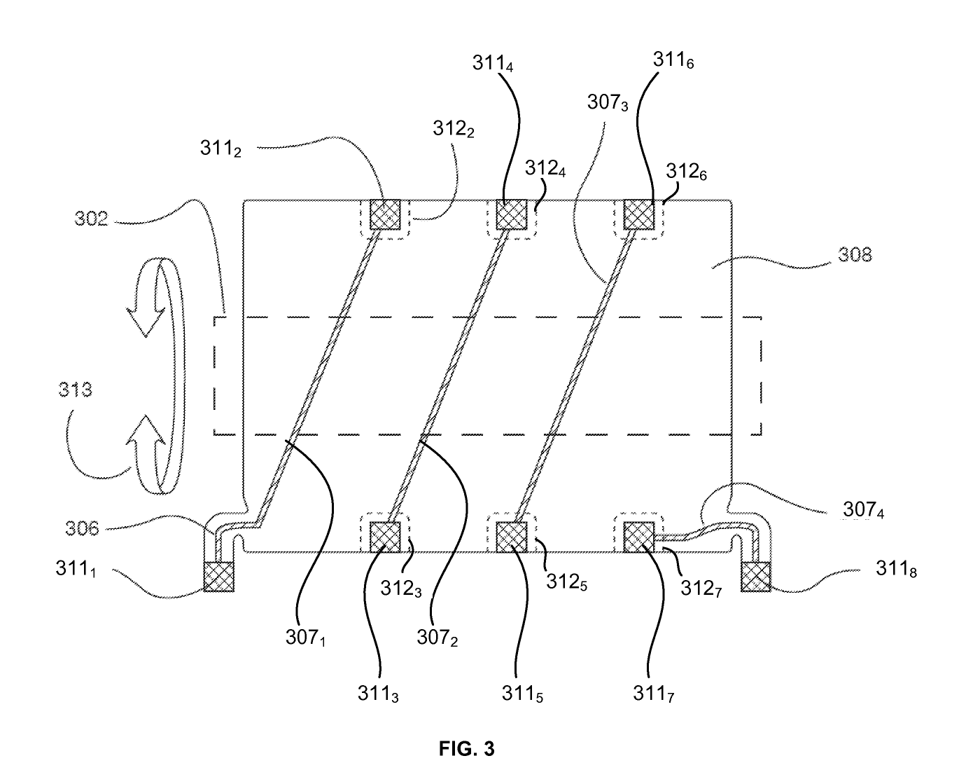

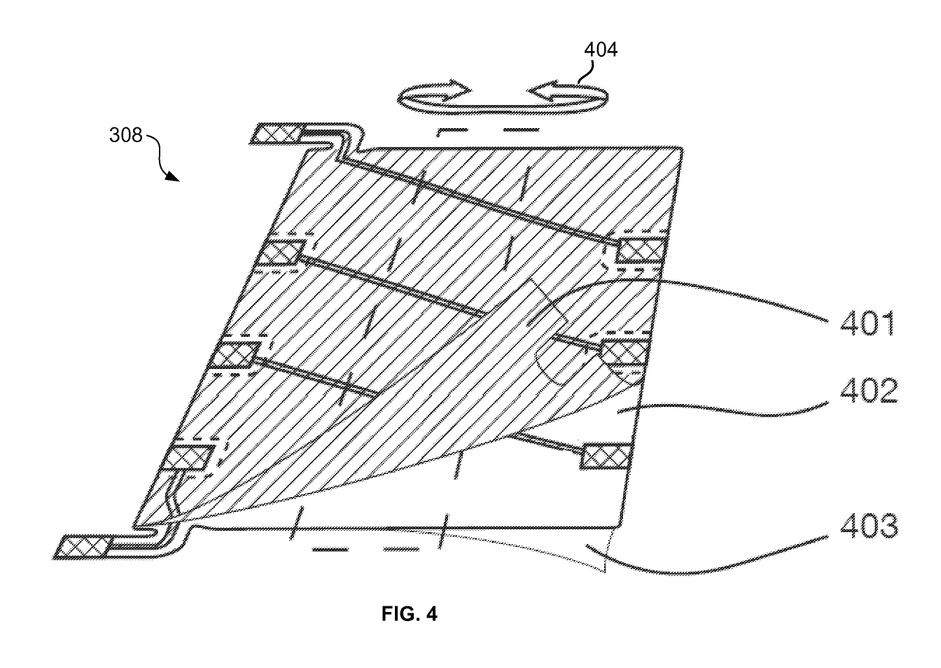

FIG. 3 is a plan view of an exemplary multi-layer antenna sleeve. Shown in FIG. 3 is a multi-layer antenna sleeve 308 (see FIG. 4 for details of exemplary layers), comprising traces 307₁-307₄, and solder lands 311₁-311₈. The dashed line 302 is the outline of an exemplary battery around which the sleeve 308 may be wrapped (as indicated by the arrow 313).

In an exemplary embodiment of the invention, the sleeve 308 may be metallized on both sides in the locations of the solder lands 311₁-311₈. In another exemplary embodiment, the solder lands 311₂, 311₄, and 311₆ may be on a first side of the sleeve 308 and the solder lands 311₁, 311₃, and 311₇ may be on a second side of the sleeve 308. In either embodiment, when the sleeve 308 is wrapped around the battery (or simply bent or molded into the shape of the battery, if the battery is not present), one edge of the sleeve 308 may overlap the opposite edge of the sleeve 308 such that the solder land 311₂ may contact, and be soldered to, the solder land 311₃, the solder land 311₄ may contact, and be soldered to, the solder land 311₅, and the solder land 311₆ may contact, and be soldered to, the solder land 311₇. With the three solder connections made, the traces 307₁-307₄ may form a continuous conductive path from solder tab 311₁, which may serve as a first antenna lead, to solder tab 311₈, which may serve as a second antenna lead.

The dashed lines 312₂-312₇ indicate cutout regions of a top and/or bottom layer to expose the solder land 311₂-311₇, respectively, for soldering.

FIG. 4 depicts various layers of the antenna sleeve shown in FIG. 3. Shown in FIG. 4 is the antenna sleeve 308 comprising a ferromagnetic laminate 401, a substrate 402, and a dielectric laminate 403.

In an exemplary embodiment of the invention, the ferromagnetic laminate 401 may have cut-outs to expose the solder lands fabricated in and/or on substrate 402. When the sleeve 308 is wrapped around a battery in the direction of the arrow 404, the ferromagnetic laminate 401 may be internal to the helical antenna formed by the traces embedding in and/or on the substrate 402. In another exemplary embodiment of the invention,

The substrate 402 may be made of an insulator, a dielectric material, and/or any material on which metal traces and contacts can be fabricated. The metal traces and solder lands may be fabricated on the substrate 402 through any suitable method such as, for example, deposition, stamping, and/or etching

The dielectric laminate 403 may be made of a dielectric material. The dielectric laminate 403 may have cut-outs to expose the solder lands fabricated in and/or on the substrate 402.

FIG. 5 depicts an exemplary smartcard comprising an integrated batter and antenna. The smartcard 500 may be a multi-band, multi-mode smartcard operable to transmit and/or receive in the industrial, scientific, and medical (ISM) band centered at 433.92 MHz and/or in the ISM band centered at 13.56 MHz. The smartcard 500 may be ISO 7816 compliant. The smartcard 500 may be as described in the above-incorporated U.S. patent application Ser. No. 13/270,802 entitled “Method and Apparatus for a Multi-band, Multi-mode Smartcard,” filed on Oct. 11, 2011. The smartcard 500 may comprise an apparatus 502, which may comprise, for example, the battery 102 and the antenna sleeve 308.

Various aspects of a method and system for an integrated antenna are provided. In an exemplary embodiment of the invention, a substrate 402 may comprise one or more metal traces 307 thereon and/or embedded therein. The substrate 402 may be sufficiently flexible to be bent or molded into a shape that corresponds to the outer dimensions of a battery 102. When the substrate is bent into the shape corresponding to the outer dimensions of the battery 102, the one or more metal traces 207 may form a helical antenna. The shape that corresponds to the outer dimensions of a battery may, for example, be substantially elliptical or substantially rectangular.

In instances that there are a plurality of metal traces 107, the substrate 402 may comprise a plurality of solder lands 311 thereon and/or embedded therein. When the substrate is wrapped around the battery, the solder lands 311 may electrically connect the plurality of conductive traces to form one conductive path, which is the helical antenna. A first one of the plurality of traces 207 may terminate at a first solder land 311₁, and a second one of the plurality of traces 107 may terminate at a second solder land 311₇. The first solder land 311₁ may be utilized as a positive terminal of the helical antenna for coupling signals to and/or from the antenna. The second solder land 311₇ may be utilized as a negative terminal of the helical antenna to couple signals to and/or from the antenna. A dielectric layer may be affixed to one side of the substrate. A ferromagnetic layer may be affixed to one side of the substrate such that the ferromagnetic material is interior to the helical antenna when the substrate 402 is bent into the shape that corresponds to an outer dimension of the battery 102. An antenna driving circuit 209 may be mounted to the substrate. The substrate 402 and battery 102 may be embedded in a device, such as smartcard 500, that is operable to transmit and/or receive in the industrial, scientific, and medical band centered at 433.92 MHz.

In an exemplary embodiment of the invention, a battery may be within a sleeve, such as sleeve 308, which comprises one or more metal traces arranged to form an antenna 207. The battery sleeve 308 may comprise a substrate 402 on which the one or more metal traces 207 are fabricated, a ferromagnetic laminate 401 on a first side of the substrate 402, and a dielectric laminate 403 on a second side of the substrate 402. An antenna driving circuit 209 is mounted on the substrate 402. The antenna may be a loop antenna, and the ferromagnetic layer may be interior to the loop antenna. Alternatively, the antenna may be a helical antenna, and the ferromagnetic layer may be interior to the helical antenna. The battery 102 and the battery sleeve 308 may be embedded in a device, such as the smartcard 500, that is operable to transmit and/or receive in the industrial, scientific, and medical band centered at 433.92 MHz.

In an exemplary embodiment of the invention, an ISO 7816 compliant smartcard may comprise a battery 102 with a battery sleeve 308 around it, and the battery sleeve 308 may comprise one or more metal traces 207 arranged to form an antenna 107. The battery sleeve 308 may comprise a substrate 402 on which the one or more metal traces 207 are fabricated, a ferromagnetic laminate 401 on a first side of the substrate 402, and a dielectric laminate 403 on a second side of the substrate 402. The antenna may be, for example, a helical antenna or a loop antenna.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for an integrated antenna.

Accordingly, the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system comprising:
a substrate with one or more metal traces thereon and/or embedded therein, wherein:
said substrate is sufficiently flexible to be bent into a shape that corresponds to the outer dimensions of a battery; and
when said substrate is bent into said shape, said one or more metal traces form a helical antenna.

2. The system of claim 1, wherein said shape that corresponds to the outer dimensions of a battery is substantially elliptical.

3. The system of claim 1, wherein said shape that corresponds to the outer dimensions of a battery is substantially rectangular.

4. The system of claim 1, wherein:
said one or more metal traces comprises a plurality of metal traces;
said substrate comprises a plurality of solder lands thereon and/or embedded therein; and
when said substrate is wrapped around said battery, said solder lands electrically connect said plurality of metal traces to form one conductive path.

5. The system of claim 4, wherein:
a first one of said plurality of traces terminates at a first of said solder lands;
a second one of said plurality of traces terminates a second one of said solder lands;
said first solder land is a positive terminal of said helical antenna;
said second solder land is a negative terminal of said helical antenna.

6. The system of claim 1, wherein an antenna driving circuit is mounted to said substrate.

7. The system of claim 1, comprising a dielectric layer affixed to one side of said substrate.

8. The system of claim 1, comprising a ferromagnetic layer affixed to one side of said substrate such that said ferromagnetic material is interior to said helical antenna when said substrate is bent into said shape.

9. The system of claim 1, wherein said substrate is embedded in a device operable to transmit and/or receive in the industrial, scientific, and medical band centered at 433.92 MHz.

10. The system of claim 9, wherein said device is an ISO 7816 compliant smartcard.

11. A system comprising:
a battery with a battery sleeve around it, said battery sleeve comprising one or more metal traces arranged to form an antenna.

12. The system of claim 11, wherein said battery sleeve comprises:
a substrate on which said one or more metal traces are fabricated;
a ferromagnetic laminate on a first side of said substrate; and
a dielectric laminate on a second side of said substrate.

13. The system of claim 12, wherein an antenna driving circuit is mounted on said substrate.

14. The system of claim 11, wherein:
said antenna is a loop antenna; and
said ferromagnetic layer is interior to said loop antenna.

15. The system of claim 11, wherein:
said antenna is a helical antenna; and
said ferromagnetic layer is interior to said helical antenna.

16. The system of claim 11, wherein said battery and said battery sleeve are embedded in a device operable to transmit and/or receive in the industrial, scientific, and medical band centered at 433.92 MHz.

17. A system comprising:
an ISO 7816 compliant smartcard, said smartcard comprising a battery with a battery sleeve around it, said battery sleeve comprising one or more metal traces arranged to form an antenna.

18. The system of claim 17, wherein said battery sleeve comprises:
a substrate on which said one or more metal traces are fabricated;
a ferromagnetic laminate on a first side of said substrate; and
a dielectric laminate on a second side of said substrate.

19. The method of claim 18, wherein said antenna is a helical antenna.

20. The method of claim 18, wherein said antenna is a loop antenna.
